(19) United States
(12) Patent Application Publication
(10) Pub. No.: US 2022/0412126 A1
(43) Pub. Date: Dec. 29, 2022

(54) MULTI-SEGMENTED METER RING

(71) Applicant: INNER-TITE CORP., HOLDEN, MA (US)

(72) Inventor: STEPHEN P. SPINNEY, GRAFTON, MA (US)

(73) Assignee: INNER-TITE CORP., HOLDEN, MA (US)

(21) Appl. No.: 17/848,445

(22) Filed: Jun. 24, 2022

Related U.S. Application Data
(60) Provisional application No. 63/216,077, filed on Jun. 29, 2021.

(51) Int. Cl. E05B 65/00

(52) U.S. Cl. CPC E05B 65/0089

(57) ABSTRACT

A locking ring assembly of the type employed to prevent unauthorized access to a meter, comprising a multi-segmented meter retaining ring, to one end of which a housing is secured; the housing having a lock receiving opening and a side opening therein; a ring clip with a lock receiving opening is secured to a second end of the meter ring and enters the housing through the side opening. A cylindrical barrel lock or other locking device is received in the housing through the lock receiving openings to maintain the meter ring in a closed condition.

### CROSS-REFERENCE TO RELATED APPLICATIONS

This application claims the benefit of U.S. Provisional Application Ser. No. 63/216,077 filed on Jun. 29, 2021, which is hereby incorporated by reference herein in its entirety.

### TECHNICAL FIELD

This invention relates generally to utility meters and in particular with an improved locking assembly of the type employed to prevent unauthorized access to such meters.

### DISCUSSION OF ART

The conventional utility meter includes a housing containing the meter mechanism. A circular front port in the housing affords access to the meter mechanism in addition to displaying a meter display. The circular housing port is surrounded by a peripheral flange adapted to mate in face-to-face abutting relationship with a peripheral flange on a glass or composite bowl covering the front housing port. In order to maintain the glass or composite bowl in place and thereby prevent unauthorized access to the meter mechanism, locking ring assemblies are employed to radially and axially confine the mating housing and bowl flanges.

Earlier hinged locking ring assemblies, as disclosed for example in U.S. Pat. No. 4,611,478 (Carlson et al) were subdivided into two mating semi-circular halves connected together by a hinge. This arrangement was easy to assemble, but the hinge connection between the ring halves offered less than adequate resistance to tampering by unauthorized personnel and would not allow easy installation onto multiple meter housings that were mounted in close proximity to each other.

U.S. Pat. No. 4,828,300 (Agbay) discloses a further improvement, which retains the advantageous features of the Carlson et al design while eliminating the connecting hinge in favor of a redesigned rear flange having a special tapered configuration allowing the ends of the ring to be more easily spread during mounting and removal. While these rings proved to be effective in their day, they do not work well with the newer composite AMI meter housings, which sometimes may be larger than the industry standard or have other irregularities preventing standard meter locking rings from being employed.

### SUMMARY OF THE INVENTION

The locking ring of the present invention comprises an integral assembly of multiple ring segments and other components fabricated on standard presses, eliminating the stresses incurred during a typical coiling fabrication process. The ring components are assembled in a tamper proof yet flexible interlocked relationship which relies on press fitting, bending, welding, and swaging. The resulting assembly is thus easy to open and close with minimal effort, is able to be installed in tight locations like pedestals and gang-type installations, is highly resistant to tampering by unauthorized personnel providing a high level of security, is able to be installed on a wider variety of out-of-tolerance or irregular meters, and sockets into a lightweight and extremely strong assembly.

These and other objects and advantages of the present invention will be described hereinafter in greater detail with reference to the accompanying drawings, wherein:

### BRIEF DESCRIPTION OF THE DRAWINGS

FIG. 1 depicts a utility meter incorporating a multi-segmented meter ring, in accordance with an embodiment of the present invention;

FIG. 2 depicts the multi-segmented meter ring of FIG. 1 in a constricted condition;

FIG. 3 depicts the multi-segmented meter ring of FIG. 1 in an enlarged condition;

FIG. 4 depicts a portion of the multi-segmented meter ring of FIG. 2;

FIG. 5 depicts a sectional view of the portion of the multi-segmented meter ring of FIG. 4; and

FIG. 6 depicts the multi-segmented meter ring of FIG. 1 being installed on one electric meter in a gang of electric meters along with a prior art hinged meter ring and a prior art stretched-type meter ring being installed on the other electric meters.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts, without duplicative description.

As used herein, the terms “substantially,” “generally,” and “about” indicate conditions within reasonably achievable manufacturing and assembly tolerances, relative to ideal desired conditions suitable for achieving the functional purpose of a component or assembly.

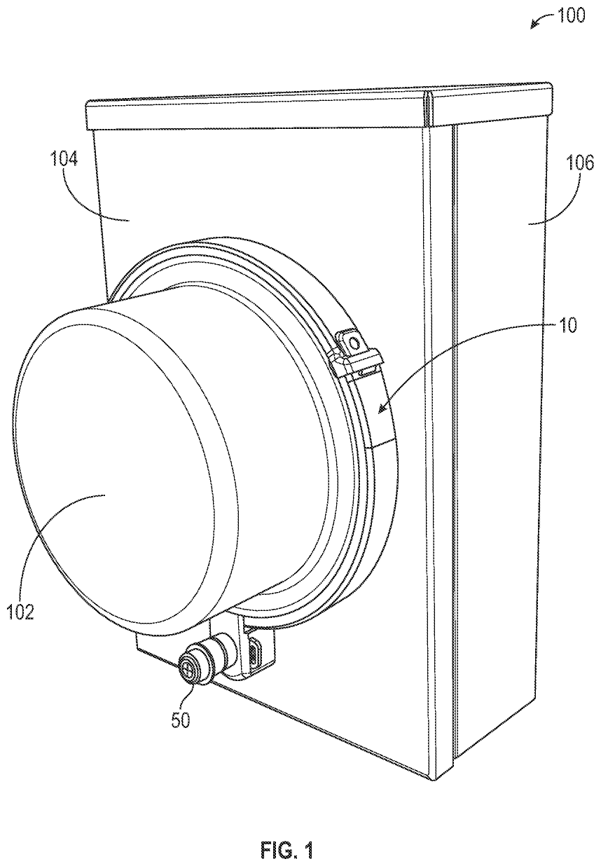

Referring initially to FIG. 1, a typical utility meter box installation 100 employing a multi-segmented meter ring, in accordance with an embodiment of the present invention, is generally depicted at 10. The electric metering mechanism (not shown) is enclosed by a glass or composite bowl 102 removably plugged into a meter box 106 mounted to the face of the meter box cover 104 of the meter box 106. The bowl 102 and cover 104 are provided with coaxially aligned circular rims, respectively (not depicted). The multi-segmented meter ring 10 is employed to secure the rims of the bowl 102 and the cover 104 to one another in an axially aligned and abutting relationship.

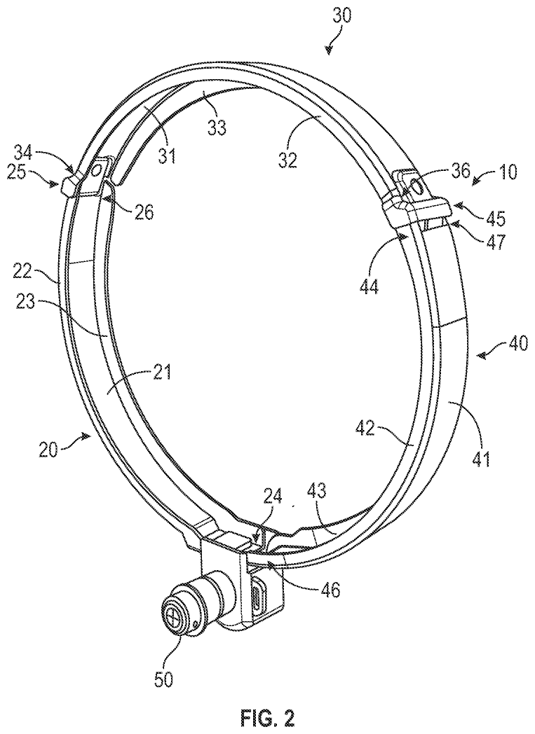

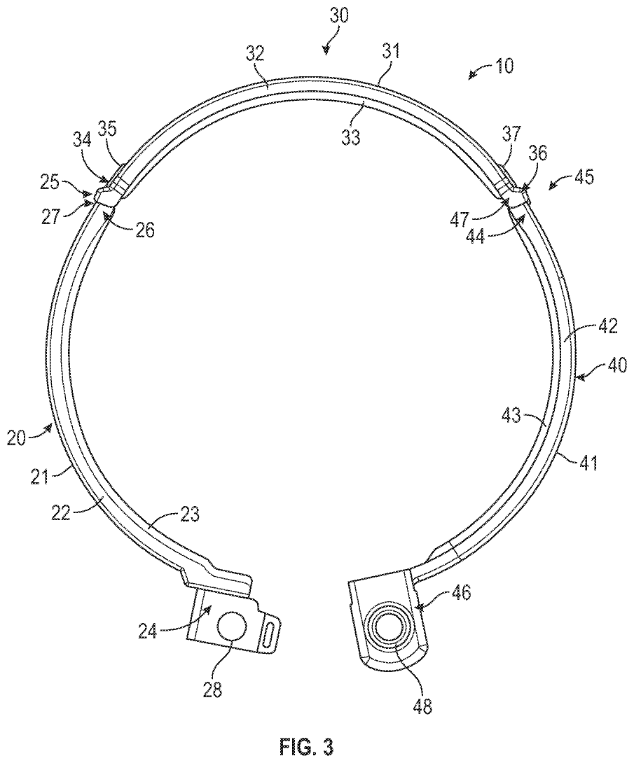

With reference additionally to FIGS. 2 and 3, it will be seen that the multi-segmented meter ring 10 has three meter ring segments 20, 30, 40 each having a generally channel-shaped cross section defined by a circular side wall 21, 31, 41 with radially inwardly protruding front and rear flanges 22, 23, 32, 33, 42, 43. While an embodiment with three meter ring segments is depicted, it is possible for a greater number of meter ring segments or incorporating meter ring segments of different sizes, in other embodiments, so long as the functionality described herein is maintained.

Referring to FIG. 3, the side wall 21 of the first meter ring segment 20 curves from a first end defined by a female end 24 to a second end 26, the side wall 31 of the second meter ring segment 30 curves from a first end 34 to a second end 36, and the side wall 41 of the third meter ring segment 40 curves from a first end 44 to a second end defined by a male end 46. A bushing 48 is contained in the male end 46 of the third meter ring segment 40 and an aperture 28 is secured to the female end 24 of the first meter ring segment 20.

The meter ring 10 is resiliently adjustable between an open or enlarged condition as shown in FIG. 3, which accommodates its installation on and removal from the rims of the bowl 102 and cover 104, and a closed or constricted condition as shown in FIGS. 1 and 2, where the rims of the bowl 102 and cover 104 are both radially and axially confined by the channel-shaped side walls 22, 23, 32, 33, 42, 43 of the first meter ring segment 20, the second meter ring segment 30, and the third meter ring segment 40. In the enlarged condition shown in FIG. 3, the bushing 48 and aperture 28 lie on parallel axes, whereas in the constricted condition as shown in FIGS. 1 and 2, the bushing 48 and aperture 28 (not depicted) are aligned coaxially and in communication one with the other.

Referring to FIGS. 1 and 2, an industry standard barrel lock 50 serves as the means for maintaining the ring in its constricted condition. Once the aperture 28 and bushing 48 have been brought into coaxial alignment, the lock may be advanced from a preloaded, unlocked position to a locked position.

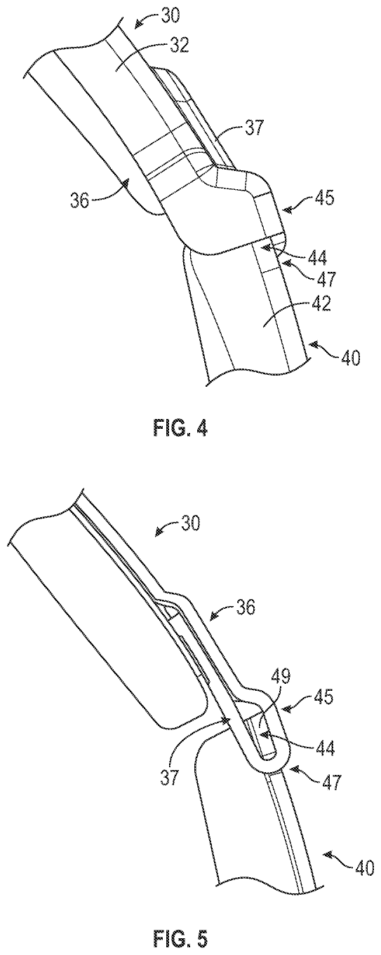

Referring to FIGS. 2-5, the first meter ring segment 20 engages the second meter ring segment 30 at a first joint 25 and the second meter ring segment 30 engages the third meter ring segment 40 at a second joint 45. The first joint 25 and the second joint 45 are integral mechanical joints or articulating joints. The first joint 25 is formed by a first meter ring extension 35 reaching through a first aperture 27 in the first meter ring segment 20 and fastening to the second meter ring segment 30 to form an integral metal joint. The first joint 25 is similar to the second joint 45 in structure and function such that the detailed depiction of the second joint 45 in FIGS. 4 and 5 accurately represents the structure and functionality of the first joint 25 with the detailed description of the elements as set forth herein.

Referring to FIGS. 4 and 5, the second joint 45 is formed by a second meter ring extension 37 reaching through a second aperture 47 in the third meter ring segment 40 and fastening to the second meter ring segment 30 to form an integral metal joint. The second meter ring extension 37 loops around a bridge 49 of the third meter ring segment 40. The bridge 49 is a portion of the side wall 41 of the third meter ring segment 40 as defined by an edge of the second aperture 47. The size of the first aperture 27 and the second aperture 47 and/or deformation of the first meter ring extension 35 and the second meter ring extension 37 into a crimped shape prevent substantial circumferential movement of the first meter ring segment 20, the second meter ring segment 30, and the third meter ring segment 40 relative to one another. This arrangement allows for accommodation of a larger bowl 102 without negatively impacting the security and/or mechanical stability of the meter ring 10. In some embodiments, the first meter ring extension 35 and/or the second meter ring extension 45 are welded to themselves to retain the first meter ring segment 20, the second meter ring segment 30, and the third meter ring segment 40 in a desired position, but these optional welds do not substantially contribute to the structural integrity of the first joint 25 or the second joint 45. The first joint 25 and the second joint 45 eliminate the need for separate mechanically attached hinges and/or structural welds, improving the security of the assembly without the need for complex installation procedures or additional components to minimize cost. The first joint 25 and the second joint 45 provide for a no-strain installation process that proactively addresses repetitive motion concerns that could subject the meter ring 10 to failure and/or inefficient retention of the bowl 102 to the cover 104. Eliminating a hinge pin at these locations also removes a potential failure point.

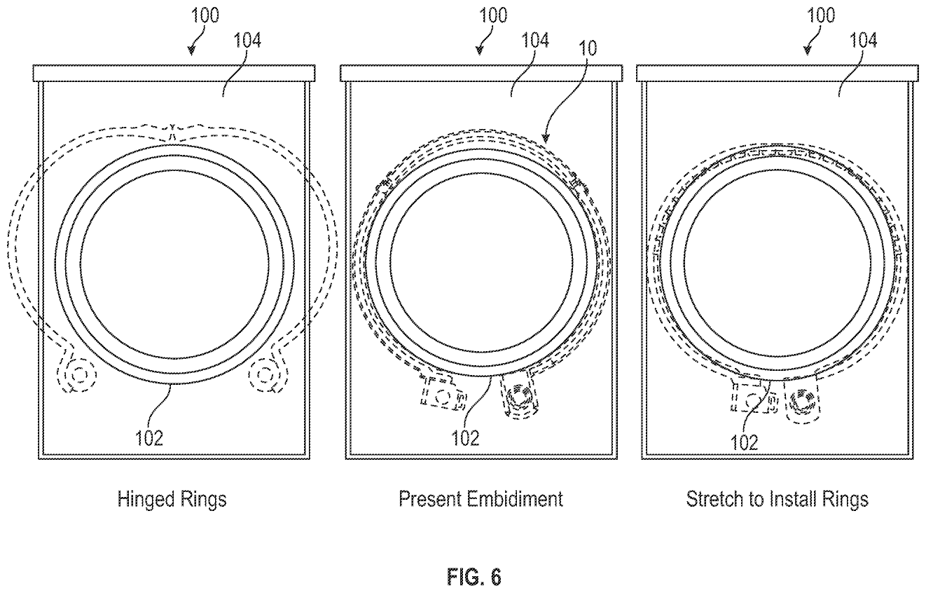

The multi-segment design of the meter ring 10 also reduces distortion of the meter ring 10, the rim of the bowl 102, and/or the rim of the cover 104. The meter ring 10 eliminates the need for rear-flange reliefs or cut-outs because the first and second joints 25, 45 provide easy opening and closing of the meter ring 10 around the utility meter and socket flange. The first meter ring segment 20, the second meter ring segment 30, and the third meter ring segment 40 have solid rear flange segments 23, 33, 43 that provide increased security over relieved rear flanges of the prior art. The multi-segment design of the meter ring 10 also eliminates the need for straightening and rounding operations after heat treating, thereby reducing manufacturing and fabrication costs. Fast and easy operation of the removal and installation of the meter ring 10 gets field workers in and out of the job faster, promotes improved safety, and increases productivity. When in a fully open state, the meter ring 10 can be installed in tighter spaces than meter rings with a single hinge, which is ideal for multi-gang utility meter applications as shown in FIG. 6. The clearance between adjacent utility meters in multi-gang utility meter applications makes it difficult and in some cases impossible to easily and securely install prior art meter rings on the utility meters. The high strength design of the meter ring 10 is lightweight and easy to carry, which is significantly beneficial for Advanced Metering Infrastructure (“AMI”) deployments and/or disconnect work.

It is further to be understood that the above description is intended to be illustrative, and not restrictive. For example, the above-described embodiments (and/or aspects thereof) may be used in combination with each other. Additionally, many modifications may be made to adapt a particular situation or material to the teachings of the invention without departing from its scope.

Additionally, while the dimensions and types of materials described herein are intended to define the parameters of the invention, they are by no means limiting and are exemplary embodiments. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, terms such as “first,” “second,” “third,” “upper,” “lower,” “bottom,” “top,” etc. are used merely as labels, and are not intended to impose numerical or positional requirements on their objects. Further, the limitations of the following claims are not written in means-plus-function format are not intended to be interpreted as such, unless and until such claim limitations expressly use the phrase “means for” followed by a statement of function void of further structure.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes may be made in the above-described invention, without departing from the spirit and scope of the invention herein involved, it is intended that all of the subject matter of the above description shown in the accompanying drawings shall be interpreted merely as examples illustrating the inventive concept herein and shall not be construed as limiting the invention.

1. A locking ring assembly for detachably interconnecting a pair of circular rims in an axially aligned abutting relationship, the assembly comprising:
a multi-segmented meter ring having first and second ends and a circular side wall with front and rear flanges protruding radially inwardly therefrom, the meter ring allowing low effort and resilient adjustment between an open condition accommodating installation and removal of the meter ring onto and off of the rims and a closed condition confining the rims within the side wall and between the front and rear flanges.

2. The locking ring assembly of claim 1, wherein the meter ring has more than two meter ring segments.

3. The locking ring assembly of claim 2, wherein the meter ring alternates between the open condition and the closed condition without significant effort.

4. The locking ring assembly of claim 2, wherein the meter ring segments are attached to one another by articulating joints.

5. The locking ring assembly of claim 4, wherein each of the articulating joints comprise a meter ring extension protruding from one meter ring segment, reaching through an aperture in the other meter ring segment, and engaging a bridge of the other meter ring segment.

6. The locking ring assembly of claim 5, wherein the meter ring extension is welded to at least one of the meter ring segment and the meter ring extension without providing significant structural support.

7. The locking ring assembly of claim 1, wherein the meter ring securely fits over out-of-tolerance or irregularly shaped electric meters and socket flanges.

8. The locking ring assembly of according to any one of claims 1, further comprising a lock assembly retained within opposite ends of the meter ring, wherein all components of the lock assembly other than a barrel lock comprise metallic stampings.

9. The locking ring assembly of claim 8, wherein the components are stamped from stainless steel or carbon steel flat stock.

10. A multi-segmented meter ring, comprising:
a first meter ring segment having a cross section defined by a side wall with radially inwardly protruding front and rear flanges, the side wall curving from a first end to a second end, the first end defined by a male end and the second end defining a first aperture;
a second meter ring segment having a cross section defined by a side wall with radially inwardly protruding front and rear flanges, the side wall curving from a first end having a first meter ring extension to a second end having a second meter ring extension; and
a third meter ring segment having a cross section defined by a side wall with radially inwardly protruding front and rear flanges, the side wall curving from a first end to a second end, the first end defining a second aperture and the second end defined by a female end,
wherein the first meter ring extension reaches through the first aperture and fastens to the first meter ring segment to form a first joint and the second meter ring extension reaches through the second aperture and fastens to the third meter ring segment to form a second joint, and
wherein the first joint and the second joint allow the multi-segmented meter ring to resiliently and easily adjust between an enlarged condition and a constricted condition.

11. The multi-segmented meter ring of claim 10, wherein the constricted condition occurs when the male end of the first meter ring segment is aligned coaxially with the female end of the third meter ring segment.

12. The multi-segmented meter ring of claim 10, wherein at least one of the first joint and the second joint is an integral mechanical joint or an articulating joint.

13. The multi-segmented meter ring of claim 10, wherein the first ring extension loops around a bridge defined by an edge of the first aperture of the first meter ring segment and the second ring extension loops around a bridge defined by an edge of the second aperture of the third meter ring segment.

14. The multi-segmented meter ring of claim 10, wherein at least one of a size of the first aperture, a size of the second aperture, deformation of the first meter ring extension, and deformation of the second meter ring extension prevents substantial circumferential movement of the first meter ring segment, the second meter ring segment, and the third meter ring segment relative to one another.

15. The multi-segmented meter ring of claim 10, wherein in the constricted condition the rear flanges of the first meter ring segment, the second meter ring segment, and the third meter ring segment are solid to provide increased security.

16. A method of installing a multi-segmented meter ring on an electric motor, the method comprising:
expanding the multi-segmented meter ring to an enlarged condition;
positioning a circular rim of a bowl of the electric meter and a circular rim of a cover of the electric meter within a side wall and between a radially inwardly protruding front flange and a radially inwardly protruding rear flange of the multi-segmented meter ring;
compressing the multi-segmented meter ring to a constricted condition,
wherein the rim of the bowl and the rim of the cover are each radially and axially confined by the side wall, the front flange, and the rear flange of the multi-segmented meter ring, and
wherein the steps of expanding and compressing the multi-segmented meter ring do not require significant effort.

17. The method of installing a multi-segmented meter ring of claim 16, further comprising:
fixing the multi-segmented meter ring in the constricted condition with a lock after the step of compressing the multi-segmented meter ring.

18. The method of installing a multi-segmented meter ring of claim 16, wherein in the constricted condition the multi-segmented meter ring includes a solid rear flange.

19. The method of installing a multi-segmented meter ring of claim 16, wherein the steps of expanding and compressing the multi-segmented meter ring do not deform a material of the multi-segmented meter ring.

20. The method of installing a multi-segmented meter ring of claim 16, wherein in the constricted condition the meter ring securely fits over out-of-tolerance or irregularly shaped electric meters and socket flanges.
